(19) United States
(12) Patent Application Publication
(10) Pub. No.: US 2009/0307595 A1
(43) Pub. Date: Dec. 10, 2009

(54) System and method for associating semantically parsed verbal communications with gestures

(76) Inventors: Jason T. Clark, Raleigh, NC (US); Ami H. Dewar, Durham, NC (US); Robert C. Leah, Cary, NC (US); Nicholas E. Poore, Durham, NC (US); Peter C. Yim, Raleigh, NC (US)

Correspondence Address: HOLMAN IP LAW/IBM RSW, 175 S Main Street, Suite #850, Salt Lake City, UT, 84111, US

(21) Appl. No.: 12/135,328

(22) Filed: Jun. 9, 2008

(51) Int. Cl. G06F 3/048; G06F 17/30

(52) U.S. Cl. 715/728; 707/100; 707/E17.044

(57) ABSTRACT

A metaverse system and method for dynamically enacting syntax-based gestures in association with a metaverse application. The metaverse system includes a metaverse server and a semantic gesturing engine. The metaverse server executes a metaverse application. The metaverse application allows metaverse application allows a user on the client computer to enter a metaverse virtual world as an avatar via a metaverse client viewer. The semantic gesturing engine is coupled to the metaverse server and identifies a verbal communication from the avatar within the metaverse application, dynamically selects a gesture associated with the verbal communication in response to a determination that an association exists between the verbal communication and the gesture, and dynamically executes the selected gesture to cause the avatar to enact the selected gesture in conjunction with conveying the verbal communication.

### BACKGROUND

The term metaverse is widely used to describe a fully immersive 3D virtual space, a virtual environment where humans are represented by an avatar and may interact with other user's avatars, both socially and economically, as well as with software agents in a cyber space. The environment in a metaverse is built upon a metaphor of the real world, but in some cases, without the physical limitations of the real world. In a metaverse application, such as Second Life®, users are allowed to have friends, create groups, and talk and mingle with strangers, fly, and teleport to different locations, and between different metaverses.

Currently, a user in a metaverse is able to communicate with other users in the metaverse in real-time by entering text or through the use of a microphone connected to the user's computer. In the case of using a microphone, the user speaks into the microphone, and the user's computer converts the audio input from the user to a digitally sampled version. The digital version of the audio is then relayed from the user's computer to the other user's computer over the internet using a protocol such as Voice Over Internet Protocol (VOIP). Additionally, a user in a metaverse is able to select from a list gestures such as hand waving, laughing, sitting, dancing, etc. Except for gestures that the user can manually instruct the user's avatar to enact, there is no way to simulate human behavior through the user's avatar beyond the default simple movements selected from the list of gestures standard to all avatars while speaking to other user's in the metaverse application via a microphone. Currently, a user may communicate to other users in the metaverse application and then try to synchronize a selected gesture with the words the user is presently speaking in the microphone, or typing. This allows the user to manually attempt to match the emotion and expressions of the user while speaking into the microphone or typing. However, many times, the timing of what is being communicated does not synchronize well with the gestures, and there is often a perceptible mismatch between the user's spoken and/or typed words with the user's manually selected avatar gestures.

### SUMMARY

Embodiments of a system are described. In one embodiment, the system is a metaverse system to allow a user to dynamically enact syntax-based gestures in association with a metaverse application. The metaverse system includes a metaverse server and a semantic gesturing engine. The metaverse server executes a metaverse application. The metaverse application allows metaverse application allows a user on the client computer to enter a metaverse virtual world as an avatar via a metaverse client viewer. The semantic gesturing engine is coupled to the metaverse server and identifies a verbal communication from the avatar within the metaverse application, dynamically selects a gesture associated with the verbal communication in response to a determination that an association exists between the verbal communication and the gesture, and dynamically executes the selected gesture to cause the avatar to enact the selected gesture in conjunction with conveying the verbal communication. Other embodiments of the system are also described.

Embodiments of a method are also described. In one embodiment, the method is a method for dynamically enacting syntax-based gestures in association with a metaverse application. An embodiment of the method includes identifying a verbal communication from an avatar within a metaverse application of a metaverse virtual world. The method also includes dynamically selecting a gesture associated with the verbal communication in response to a determination that an association exists between the verbal communication and the gesture. The method also includes dynamically executing the selected gesture to cause the avatar to enact the selected gesture in conjunction with conveying the verbal communication. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a schematic diagram of one embodiment of a computer network system.

FIG. 2 depicts a schematic block diagram of one embodiment of a client computer of the computer network system of FIG. 1.

FIG. 3 depicts a schematic block diagram of one embodiment of a metaverse server with a semantic gesturing engine.

FIGS. 4A and 4B depict schematic block diagrams of one embodiment of semantic and gesture associations stored in the syntax and gesture databases of FIGS. 2 and 3.

FIG. 5 depicts a schematic flow chart diagram of one embodiment of a syntax-based gesturing method for use with the semantic gesturing engine of FIG. 3.

FIG. 6 depicts a schematic flow chart diagram of one embodiment of a syntax-based gesturing configuration method for use with the semantic gesturing engine of FIG. 3.

Throughout the description, similar reference numbers may be used to identify similar elements.

### DETAILED DESCRIPTION OF THE INVENTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate a metaverse server to dynamically select a gesture that is pre-associated with elements of semantically parsed text strings entered by a user and semantically parsed voice-to-text strings spoken by the user. An example of a metaverse server includes a server for Second Life®. This and other metaverse servers serve a virtual world simulation, or metaverse, through a software application that may be stored and executed on a computer system. Additionally, some embodiments facilitate configuring associations between text strings and semantic meanings, semantic meanings and gestures, and direct associations between text strings and gestures. Additionally, some embodiments facilitate storing associations among text strings, gestures, and semantic meanings in one or more databases.

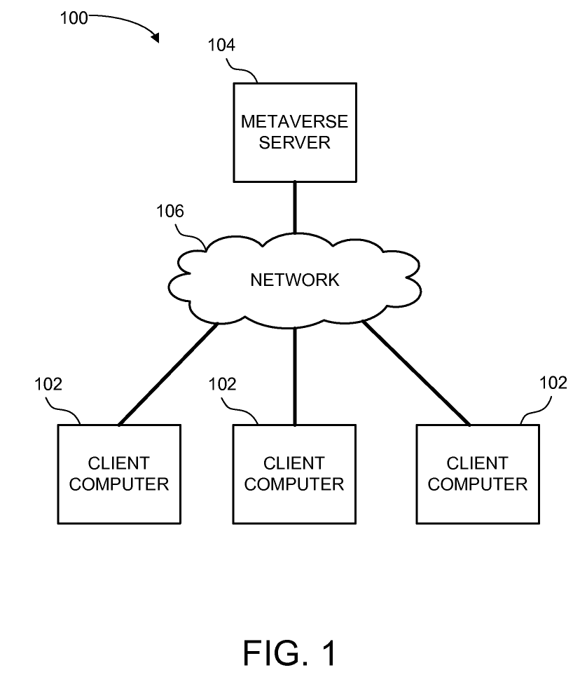

FIG. 1 depicts a schematic diagram of one embodiment of a computer network system 100. The computer network system 100 may interface a system user and a metaverse server 104 according to the interface operations of a client computer 102. The illustrated computer network system 100 includes a client computer 102, a metaverse server 104, and a network 106. Although the depicted computer network system 100 is shown and described herein with certain components and functionality, other embodiments of the computer network system 100 may be implemented with fewer or more components or with less or more functionality. For example, some embodiments of the computer network system 100 include a plurality of metaverse servers 104 and a plurality of networks 106. Additionally, some embodiments of the computer network system 100 include similar components arranged in another manner to provide similar functionality, in one or more aspects.

The client computer 102 manages the interface between the system user and the metaverse server 104. In one embodiment, the client computer 102 is a desktop or laptop computer. In other embodiments, the client computer 102 is a mobile computing device that allows a user to connect to and interact with a metaverse. In some embodiments, the client computer 102 is a video game console. The client computer 102 is connected to the metaverse server 104 via a local area network (LAN) or other type of network 106.

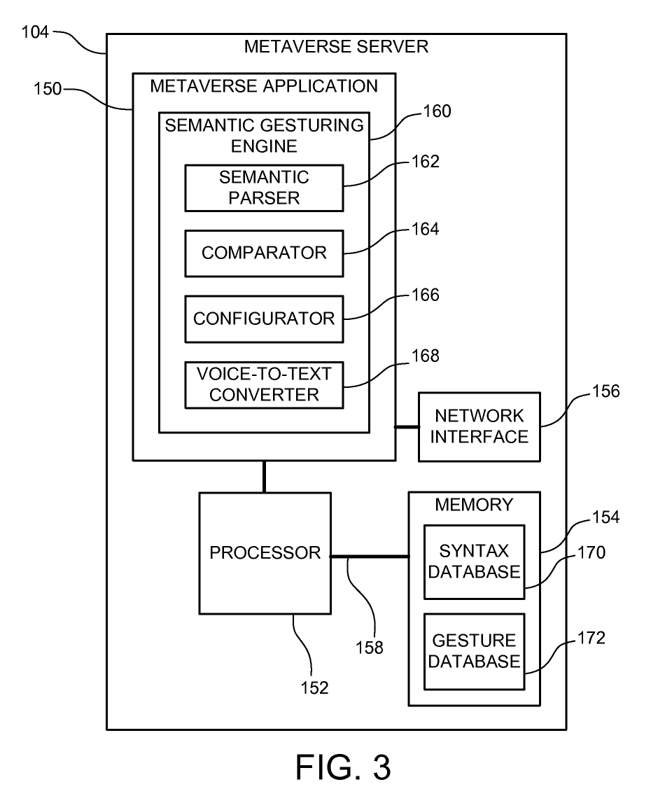

The metaverse server 104 hosts a simulated virtual world, the metaverse, to a plurality of client computer 102. In one embodiment, the metaverse server 104 is an array of servers. In some embodiments, a specified area of the metaverse is simulated by a single server instance, and multiple server instances may be run on a single metaverse server 104. In some embodiments, the metaverse server 104 includes a plurality of simulation servers dedicated to physics simulation in order to manage interactions and handle collisions between characters and objects in a metaverse. In some embodiments, the metaverse server 104 includes a plurality of storage servers dedicated to storing data related to objects and characters in the metaverse world. The data stored on the plurality of storage servers may include object shapes, avatar shapes and appearances, audio clips, metaverse related scripts, and other metaverse related objects. The plurality of storage servers may also store data associated with gesture associations, syntax associations, and text string associations as described in greater detail below in relation to FIG. 3.

The network 106 may communicate traditional block I/O such as over a storage area network (SAN). The network 106 may also communicate file I/O such as over a transmission control protocol/internet protocol (TCP/IP) network or other similar communication protocols. In some embodiments, the computer network system 100 includes two or more networks 106. In some embodiments, the client computer 102 may be connected directly to a metaverse server 104 via a backplane or system bus. In one embodiment, the network 106 may include a cellular network, another type of network, or a combination of networks.

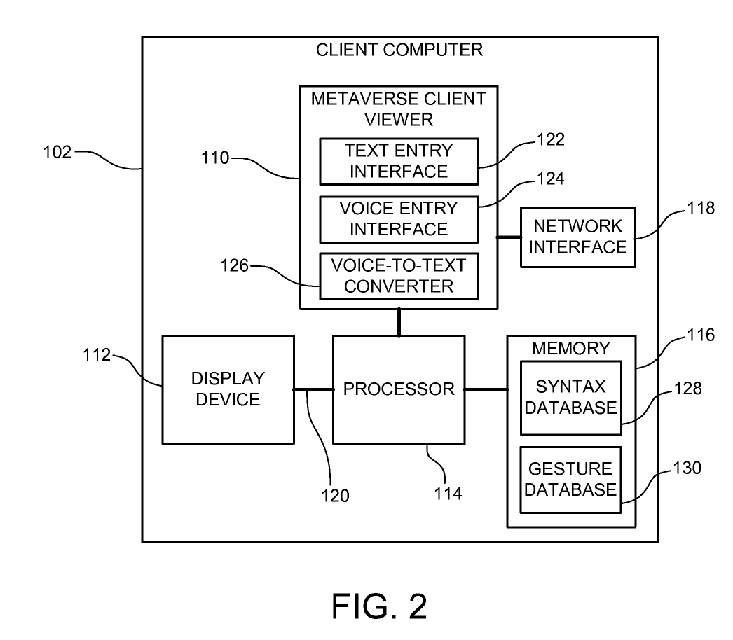

FIG. 2 depicts a schematic block diagram of one embodiment of a client computer 102 of the computer network system 100 of FIG. 1. The illustrated client computer 102 includes a metaverse client viewer 110, a display device 112, a processor 114, a memory device 116, a network interface 118, and a bus interface 120. In one embodiment, the bus interface 120 facilitate communications related to software associated with the metaverse client viewer 110 executing on the client computer 102, including processing metaverse application commands, as well as storing, sending, and receiving data packets associated with the application software of the metaverse. Although the depicted client computer 102 is shown and described herein with certain components and functionality, other embodiments of the client computer 102 may be implemented with fewer or more components or with less or more functionality.

In one embodiment, the client computer 102 of FIG. 2 implements the metaverse client viewer 110 coupled to a metaverse server 104 attached to the network 106 of FIG. 1. In some embodiments, the metaverse client viewer 110 is stored in the memory device 116 or a data storage device within the client computer 102. In some embodiments, the metaverse client viewer 110 includes processes and functions which are executed on the processor 114 within the client computer 102.

In one embodiment, the metaverse client viewer 110 is a client program executed on the client computer 102. In some embodiments, the metaverse client viewer 110 enables a user on a client computer 102 to connect to a metaverse server 104 over a network 106. The metaverse client viewer 110 is further configured to enable a user on the client computer 102 to interact with other users on other client computers 102 that are also connected to the metaverse server 104. The depicted metaverse client viewer 110 includes a text entry interface 122 to allow a user to enter text strings and to send the entered text strings to other user's in a metaverse virtual world, a voice entry interface 124 such as a microphone to allow a user to verbally speak to other user's in the metaverse virtual world, and a voice-to-text converter 126 to convert the voice of the user to text strings. In particular, the functions of the metaverse client viewer 110 allow a user to associate text strings with gestures in a metaverse virtual world. Embodiments of the process of associating text strings with gestures are described in further detail below in relation to FIG. 3.

In some embodiments, the display device 112 is a graphical display such as a cathode ray tube (CRT) monitor, a liquid crystal display (LCD) monitor, or another type of display device. In one embodiment, the display device 112 is configured to convey a visual representation of a metaverse virtual world, as well as control and configuration tools to control and configure aspects of the metaverse client viewer 110 as well as the processes related to associating text strings with gestures.

In one embodiment, the processor 114 is a central processing unit (CPU) with one or more processing cores. In other embodiments, the processor 114 is a graphical processing unit (GPU) or another type of processing device such as a general purpose processor, an application specific processor, a multi-core processor, or a microprocessor. Alternatively, a separate GPU may be coupled to the display device 112. In general, the processor 114 executes one or more instructions to provide operational functionality to the client computer 102. The instructions may be stored locally in the processor 114 or in the memory device 116. Alternatively, the instructions may be distributed across one or more devices such as the processor 114, the memory device 116, or another data storage device.

The illustrated memory device 116 includes a client syntax database 128 and a client gesture database 130. In some embodiments, the client syntax database 128 and the client gesture database 130 are used in conjunction with the processes related to associating text strings with gestures. Embodiments of the process of associating text strings with gestures are described in further detail below in relation to FIG. 3. In some embodiments, the memory device 116 is a random access memory (RAM) or another type of dynamic storage device. In other embodiments, the memory device 116 is a read-only memory (ROM) or another type of static storage device. In other embodiments, the illustrated memory device 116 is representative of both RAM and static storage memory within a single computer network system 100. In other embodiments, the memory device 116 is an electronically programmable read-only memory (EPROM) or another type of storage device. Additionally, some embodiments store the instructions related to the operational functionality of the client computer 102 as firmware such as embedded foundation code, basic input/output system (BIOS) code, or other similar code.

The network interface 118, in one embodiment, facilitates initial connections between the client computer 102 and the metaverse server 104 in response to a user on the client computer 102 requesting to login to the metaverse server 104 and to maintain a connection established between the client computer 102 and the metaverse server 104. In some embodiments, the network interface 118 handles communications and commands between the client computer 102 and the metaverse server 104. The communications and commands are exchanged over the network 106.

In one embodiment, the client computer 102, the display device 112, the processor 114, the memory device 116, the network interface 118, and other components within the computer network system 100 may be coupled to a bus interface 120. The bus interface 120 may be configured for simplex or duplex communications of data, address, and/or control information.

FIG. 3 depicts a schematic diagram of one embodiment of a metaverse server 104 with a semantic gesturing engine 160 for use in association with the metaverse client viewer 110 of FIG. 2. The illustrated metaverse server 104 includes a metaverse application 150, a processor 152, a memory device 154, a network interface 156, and a bus interface 158 to facilitate communications related to a metaverse application 150 executing on the metaverse server 104, including processing metaverse application commands, as well as storing, sending, and receiving data packets associated with the metaverse application 150. Although the depicted metaverse server 104 is shown and described herein with certain components and functionality, other embodiments of the metaverse server 104 may be implemented with fewer or more components or with less or more functionality.

In some embodiments, the metaverse server 104 of FIG. 3 implements the metaverse application 150 in conjunction with the metaverse client viewer 110 of the client computer 102. In some embodiments, the metaverse application 150 includes processes and functions which are stored on the memory device 154 and executed on the processor 152. In a further embodiment, the metaverse application 150 may be executed on a metaverse server installed on the client computer 102.

The illustrated metaverse server 104 of FIG. 3 includes many of the same or similar components as the client computer 102 of FIG. 2. These components are configured to operate in substantially the same manner described above, except as noted below.

The depicted metaverse application 150 includes a semantic gesturing engine 160. In one embodiment, the metaverse application 150 simulates a fully immersive three-dimensional virtual space, or metaverse, that a user on a client computer 102 may enter as an avatar and interact with other avatars and objects in the metaverse via the metaverse client viewer 110. Thus, a plurality of users, each on their own client computer 102, may interact and communicate with each other within the metaverse.

The depicted semantic gesturing engine 160 includes a semantic parser 162, a comparator 164, a configurator 166, and a voice-to-text converter 168. The semantic gesturing engine 160 allows a user to communicate with other users in the metaverse virtual world generated by the metaverse application 150 while the user's avatar dynamically shows appropriate expressions and/or gestures in-sync with the user's spoken and/or typed words. The appropriateness of the displayed expression and/or gesture is determined by an association made beforehand between a text string and the expression/gesture. Thus, the semantic gesturing engine 160 analyzes a text string that is generated by a user typing or converted from a user speaking into a microphone and determines whether there is a predetermined association between the analyzed text string and an expression, or gesture. When the semantic gesturing engine 160 determines that an association does exist between the analyzed text string and a gesture, the associated gesture is dynamically selected and executed so that the avatar of the user enacts the associated gesture.

In one embodiment, the semantic parser 162 determines the meaning of the text string generated by the user, whether a text string entered by the user via the text entry interface 122 or the voice of the user spoken by the user and inputted via the voice entry interface 124 and converted to a text string. The text string, whether type generated or voice generated, is sent from the client computer 102 over the network 106 to the metaverse server 104. The form of the text string is one or more words in natural language. The semantic parser 162 determines the meaning of the text string by applying semantic, morphological and/or syntactical principles to the text string.

In one embodiment, the comparator 164 compares the semantically parsed text string to a predefined index of semantic associations. In some embodiments, the comparator 164 compares the text string directly to the predefined index. In some embodiments, the comparator 164 compares the meaning of the text string derived by the semantic parser 162 to a predefined index of gesture associations. As illustrated the server memory device 154 includes a server syntax database 170 and a server gesture database. Additionally, the client memory device 116 includes the client syntax database 128 and the client gesture database 130. The syntax databases 128 and 170 include associations between a user-generated text string and the meaning of the text string. In other words, the syntax databases 128 and 170 contain associations between various text strings and the semantic, morphological and/or syntactical elements of those various text strings. The gesture databases 130 and 172 include associations between the meaning of the various text strings and expressions and/or gestures that are predefined to fit the meaning of various text strings. In as much as the semantic parser 162 is able to derive a meaning from the user generated text string, an association with the derived meaning may be found in the gesture databases 130 and 172. Alternatively, in some embodiments, the gesture databases 130 and 172 contain direct associations between a text string and an expression and/or gesture.

In some embodiments, the comparator 164 compares the user generated text string to the syntax databases 128 and 170 on the client and server sides to derive a meaning from the user generated text string in conjunction with the semantic parser 162. In some embodiments, the comparator 164 compares the semantically parsed text string to the gesture databases 130 and 172 on the client and server sides to find an association between the derived meaning of the user generated text string and an expression and/or gesture. In some embodiments, the comparator 164 compares the user generated text string directly to the gesture databases 130 and 172.

In one embodiment, the configurator 166 allows a user on a client computer 102 to configure the associations between text strings and syntax/semantics and to store the associations in the syntax databases 128 and 170. In some embodiments, the configurator 166 allows an administrator on a metaverse server 104 to configure the associations between text strings and syntax/semantics and to store the associations in the server syntax database 170. In some embodiments, the configurator 166 allows a user on a client computer 102 to configure the associations between syntax/semantics and expressions/gestures and to store such associations in the gesture databases 130 and 172. In some embodiments, the configurator 166 allows an administrator on a metaverse server 104 to configure the associations between syntax/semantics and expressions/gestures and to store such associations in the server gesture database 172. In some embodiments, the client syntax and gesture databases 128 and 130 download the associations or selections of the associations stored on the server syntax and gesture databases 170 and 172. In some embodiments, the configurator 166 allows a user and/or administrator to configure the associations between text strings and expressions/gestures directly and to store such associations on the gesture databases 130 and/or 172.

In one embodiment, the voice-to-text converter 168 converts a user generated voice sample to text form. In some embodiments, the metaverse server 104 converts a user's voice into text via the server voice-to-text-engine 168. In some embodiments, the client computer 102 converts the user's voice into text via the client voice-to-text converter 126 and sends the converted voice-to-text text string to the metaverse server 104 over the network 106.

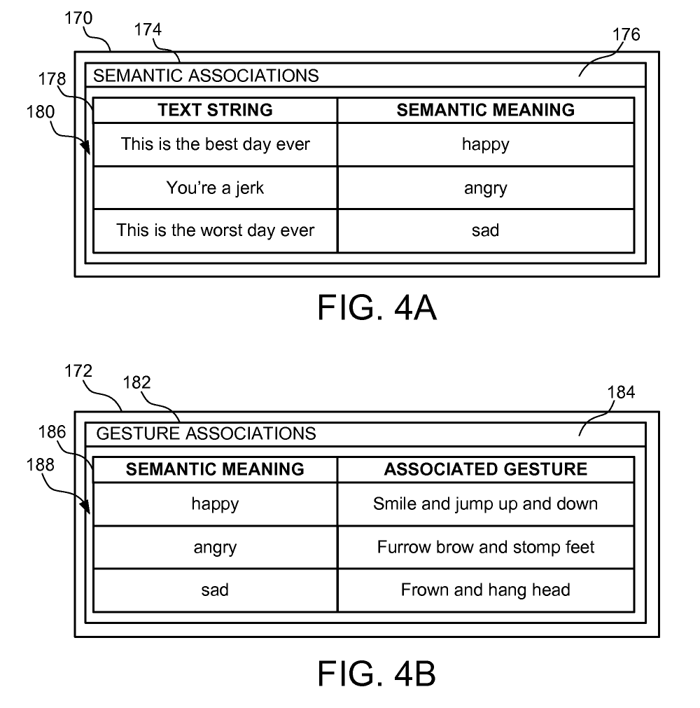

FIGS. 4A and 4B depict schematic block diagrams of one embodiment of semantic and gesture associations 174 and 182 stored in the syntax and gesture databases 128 and 130, and 170 and 172, respectively, of FIGS. 2 and 3. In particular, FIG. 4A depicts the semantic associations 174 stored in the server syntax database 170. In some embodiments, the semantic associations 174 stored in the server syntax database 170 are substantially similar to semantic associations stored in the client syntax database 128. Likewise, FIG. 4B depicts the gesture associations 182 stored in the server gesture database 172. In some embodiments, the gesture associations 182 stored in the server gesture database 172 are substantially similar to gesture associations stored in the client gesture database 130. It should be noted that other embodiments of the semantic and gesture associations 174 and 182 may be integrated with fewer or more fields in relation to a stored association.

The illustrated semantic associations 174 includes a title bar 176, a header row 178, and data rows 180. The title bar 176 depicts a title of the semantic associations 174. The header row 178 includes a text string column and a semantic meaning column. In some embodiments, the header row 178 includes fewer or more columns. As depicted, the data rows 180 include three data rows. In some embodiments, the data rows 180 include fewer or more data rows. The first data row associates a text string “This is the best day ever” with a semantic meaning “happy.” The second data row associates a text string “You're a jerk” with a semantic meaning “angry.” The third data row associates a text string “This is the worst day ever” with a semantic meaning “sad.” Hence, the server syntax database 170 stores associations between a parsed text string and a semantic meaning.

The illustrated gesture associations 182 includes a title bar 184, a header row 186, and data rows 188. The title bar 184 depicts a title of the gesture associations 182. The header row 186 includes a semantic meaning column and an associated gesture column. In some embodiments, the header row 186 includes fewer or more columns. As depicted, the data rows 188 include three data rows. In some embodiments, the data rows 188 include fewer or more data rows. The first data row associates a semantic meaning “happy” with gestures “smile and jump up and down.” The second data row associates a semantic meaning “angry” with gestures “furrow brow and stomp feet.” The third data row associates a semantic meaning “sad” with gestures “frown and hang head.” Hence, the server gesture database 172 stores associations between a semantic meaning and at least one gesture.

Alternatively, in some embodiments, the semantic and gesture associations 174 and 182 are stored together in a combined syntax and gesture database where the semantic and gesture associations 174 and 182 are stored in a combined data field including a text string field, a semantic meaning field, and an associated gesture field as a single entry.

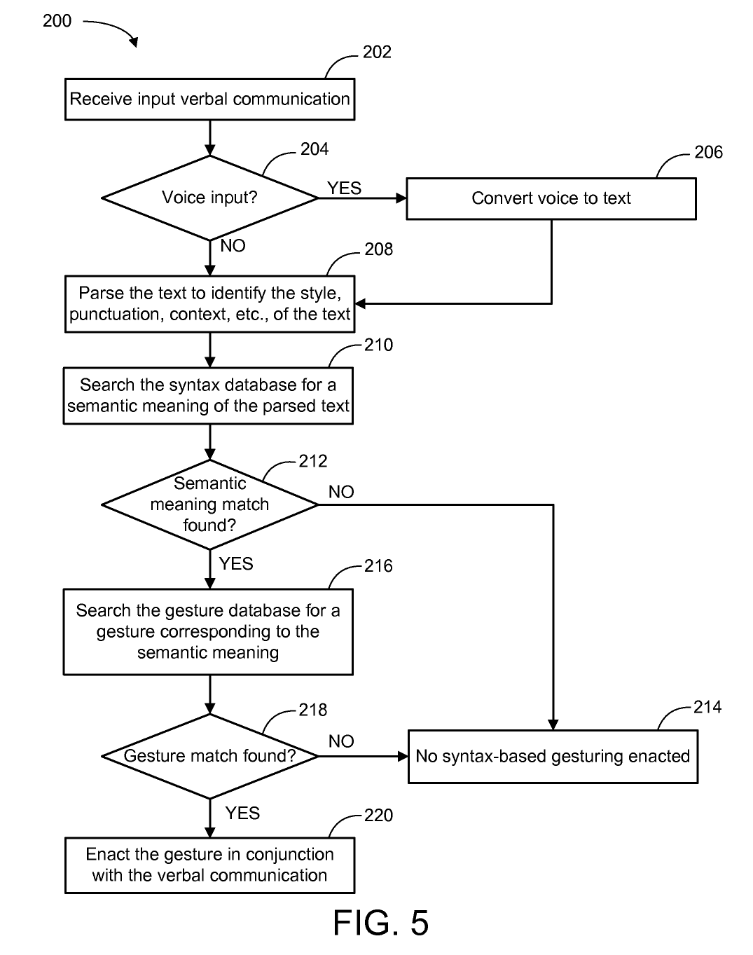

FIG. 5 depicts a schematic flow chart diagram of one embodiment of a syntax-based gesturing method 200 for use with the semantic gesturing engine 160 of FIG. 3. For ease of explanation, the syntax-based gesturing method 200 is described with reference to the semantic gesturing engine 160 of FIG. 3. However, some embodiments of the syntax-based gesturing method 200 may be implemented with other semantic gesturing engines. Additionally, the syntax-based gesturing method 200 is described in conjunction with the metaverse client viewer 110 of FIG. 2, but some embodiments of the syntax-based gesturing method 200 may be implemented with other metaverse client viewers.

In the illustrated syntax-based gesturing method 200, the semantic gesturing engine 160 receives 202 input verbal communication. In some embodiments, user generated text is inputted to the semantic gesturing engine 160. In some embodiments, the user generated text is entered by the user in the client computer 102 such as with a keyboard connected to the client computer 102. In some embodiments, the user generated text is a voice-to-text converted text string that is converted into the text string form by the client voice-to-text converter 126 or the server voice-to-text converter 168.

The semantic gesturing engine 160 determines 204 whether the input verbal communication is a voice input. If the semantic gesturing engine 160 determines 204 that the input verbal communication is a voice input, then the voice-to-text converter 168 converts the voice input to a text string. In some embodiments, when the voice of the user is converted into a text string form by the voice-to-text converter 126 on the client computer 102, the digitally sampled voice and the text string form of the voice are both transmitted to the metaverse server 104 over the network 106. The voice of the user may be transmitted over the network 106 using a voice transmission protocol such as Voice Over Internet Protocol (VOIP). Alternatively, only the voice of the user is carried over the network 106 to the metaverse server 104 and the transmitted voice of the user is then converted to text by the voice-to-text converter 168 on the metaverse server 104.

Otherwise, in one embodiment, the semantic parser 162 parses 208 the text to identify the style, punctuation, context, etc., of the text. The text string, whether type-generated or voice-generated, is examined by the semantic parser 162 on the metaverse server 104. The form of the text string is one or more words in natural or common language. The semantic parser 162 determines the meaning of the text string by applying semantic, morphological and/or syntactical principles to the text string.

In one embodiment, the semantic parser 162 searches 210 the syntax database 170 for a semantic meaning to the parsed text string. In some embodiments, the semantic gesturing engine 160 determines 212 whether a semantic meaning to the semantically parsed text string exists in the syntax database 170. When the semantic gesturing engine 160 does not find a match to the semantically parsed text string then the semantic gesturing engine 160 does not enact 214 any gesture in association with the verbal communication. Otherwise, the semantic gesturing engine 160 searches 216 the gesture database 172 for a gesture corresponding to the semantic meaning. In some embodiments, the semantic gesturing engine 160 searches 216 the gesture database 130 for a gesture corresponding to the semantic meaning.

In the illustrated syntax-based gesturing method 200, the semantic gesturing engine 160 determines 218 whether a gesture match to the semantically parsed text string exists in the client and/or server gesture databases 130 and 172. When the semantic gesturing engine 160 does not find a gesture match to the semantically parsed text string then the semantic gesturing engine 160 does not enact 214 any gesture in association with the verbal communication. Otherwise, the semantic gesturing engine 160 dynamically enacts 220 the syntax-based gesture in association with the verbal communication.

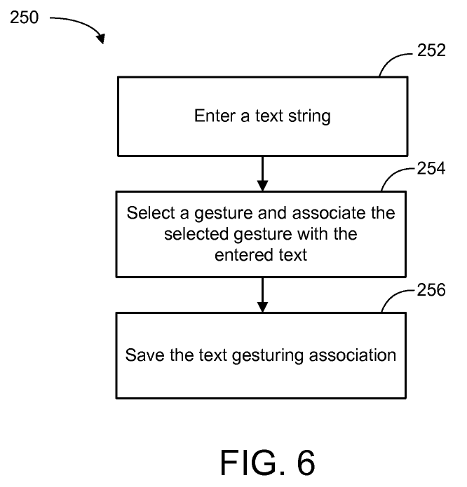

FIG. 6 depicts a schematic flow chart diagram of one embodiment of a syntax-based gesturing configuration method 250 for use with the semantic gesturing engine 160 of FIG. 3. For ease of explanation, the syntax-based gesturing configuration method 250 is described with reference to the semantic gesturing engine 160 of FIG. 3. However, some embodiments of the syntax-based gesturing configuration method 250 may be implemented with other semantic gesturing engines. Additionally, the syntax-based gesturing configuration method 250 is described in conjunction with the metaverse client viewer 110 of FIG. 2, but some embodiments of the syntax-based gesturing configuration method 250 may be implemented with other metaverse client viewers.

In the illustrated syntax-based gesturing configuration method 250, a user enters 252 a text string via the text entry interface 122 in conjunction with the configurator 166. In some embodiments, the user speaks into the voice entry interface 124 and the voice-to-text converter 126 or 168 converts the user's spoken words into a text string. The user then selects 254 a gesture from the client gesture database 130, the server gesture database 172, or another list of available gestures associated with the metaverse application 150. In some embodiments, the user creates a gesture or modifies one or more existing gestures to create a new gesture. Thus, the user selects 254 an existing gesture or a created/modified gesture to associate directly with the entered text or a semantic meaning of the entered text. The text entered by the user is associated with the selected 254 gesture via the configurator 166. The user then instructs the configurator 166 to store 256 the associations between the user generated text and the semantically parsed version of the user generated text in the client and/or server syntax databases 128 and/or 170, as well as instructs the configurator 166 to store 256 the associations between the user generated text and/or the semantically parsed version of the user generated text and the selected 254 gesture in the client and/or server gesture databases 130 and/or 172.

Embodiments of the system and method of the syntax-based gesturing process described improves the usability of the metaverse application 150, by providing a process of dynamically enacting gestures based on the syntax of communications between users in the metaverse application 150. Additionally, some embodiments facilitate improving usability of gestures in the metaverse, by providing a process to configure and associate text with gestures. Thus, by eliminating the requirement of a user to manually select gestures from a list while typing and/or speaking with other users in the metaverse application 150, a users experience in the metaverse is improved and enhanced.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to identify a verbal communication from an avatar within a metaverse application of a metaverse virtual world. The operations also include an operation to dynamically select a gesture associated with the verbal communication in response to a determination that an association exists between the verbal communication and the gesture. The operations also include an operation to dynamically execute the selected gesture to cause the avatar to enact the selected gesture in conjunction with conveying the verbal communication.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations comprising:
identify a verbal communication from an avatar within a metaverse application of a metaverse virtual world;
dynamically select a gesture associated with the verbal communication in response to a determination that an association exists between the verbal communication and the gesture; and
dynamically execute the selected gesture to cause the avatar to enact the selected gesture in conjunction with conveying the verbal communication.

2. The computer program product of claim 1, wherein the computer readable program, when executed on the computer, causes the computer to perform further operations comprising:
parse a text string; and
analyze the parsed text string to determine a meaning of the parsed text string using at least one of a plurality of semantic analysis techniques, wherein the plurality of analysis techniques comprise morphological analysis and syntactical analysis.

3. The computer program product of claim 2, wherein the computer readable program, when executed on the computer, causes the computer to perform further operations comprising:
compare the parsed text string to entries in a syntax database, wherein the entries in the syntax database define associations between elements of common text strings and a semantic meaning of the elements of the common text strings;
determine whether a match exists between the parsed text string and the entries in the syntax database;
compare a derived meaning of the text string to entries in a gesture database, wherein the derived meaning of the text string is based on the match between the parsed text string and the entries in the syntax database, wherein the entries in the gesture database define associations between the semantic meanings of the elements of the common text strings and a plurality of gestures; and
determine whether a match exists between the derived meaning of the text string and the entries in the gesture database.

4. The computer program product of claim 1, wherein the computer readable program, when executed on the computer, causes the computer to perform operations comprising:
define the association between the verbal communication and the gesture in the metaverse application; and
allow a user to modify existing associations between user generated text and at least one of a plurality of gestures in the metaverse application.

5. The computer program product of claim 1, wherein the computer readable program, when executed on the computer, causes the computer to perform operations comprising:
store associations between common text strings and semantic meanings of the common text strings, wherein the common text strings and the semantic meanings are stored in an arrangement to define associations between the common text strings and semantic meanings of the common text strings; and
store associations between the semantic meanings of common text strings and a plurality of gestures, wherein the common text strings and the semantic meanings are stored in an arrangement to define associations between the semantic meanings of common text strings and the plurality of gestures.

6. The computer program product of claim 1, wherein the computer readable program, when executed on the computer, causes the computer to perform operations comprising:
receive voice input in conjunction with the metaverse application;
convert the voice input to a text string form; and
select the gesture associated with the text string form.

7. A system comprising:
a metaverse server coupled to the client computer, the metaverse server to execute a metaverse application, wherein the metaverse application allows a user on the client computer to enter a metaverse virtual world as an avatar via a metaverse client viewer; and
a semantic gesturing engine coupled to the metaverse server, the semantic gesturing engine to identify a verbal communication from the avatar within the metaverse application, to dynamically select a gesture associated with the verbal communication in response to a determination that an association exists between the verbal communication and the gesture, and to dynamically execute the selected gesture to cause the avatar to enact the selected gesture in conjunction with conveying the verbal communication.

8. The system of claim 7, wherein the semantic gesturing engine comprises a semantic parser, the semantic parser to parse a text string and to determine a meaning of the parsed text string through semantic analysis of semantic elements in the parsed text string.

9. The system of claim 8, wherein the semantic gesturing engine further comprises a comparator, the comparator to compare the parsed text string to entries in a syntax database and to determine whether a match exists between the parsed text string and the entries in the syntax database, wherein the entries in the syntax database define associations between elements of common text strings and semantic meanings of the elements of the common text strings.

10. The system of claim 8, wherein the comparator is further configured to compare a derived meaning of the text string to entries in a gesture database, wherein the derived meaning of the text string is based on the match between the parsed text string and the entries in the syntax database, and to determine whether a match exists between the derived meaning of the text string and the entries in the gesture database, wherein the entries in the gesture database define associations between the semantic meanings of the elements of the common text strings and a plurality of gestures.

11. The system of claim 7, wherein the semantic gesturing engine further comprises a configurator, the configurator to define the association between the verbal communication and the gesture in the metaverse application and to allow the user to modify existing associations between user generated text and at least one of the plurality of gestures in the metaverse application.

12. The system of claim 7, further comprising a memory device coupled to the metaverse server wherein the memory device comprises a syntax database to store associations between common text strings and semantic meanings of common text strings.

13. The system of claim 7, further comprising a memory device coupled to the metaverse server wherein the memory device comprises a gesture database to store associations between the semantic meanings of common text strings and a plurality of gestures in the metaverse application.

14. The system of claim 7, wherein the semantic gesturing engine further comprises a voice-to-text converter to convert a voice input audio from the user to a text string form.

15. A method comprising:
identifying a verbal communication from an avatar within a metaverse application of a metaverse virtual world;
dynamically selecting a gesture associated with the verbal communication in response to a determination that an association exists between the verbal communication and the gesture; and
dynamically executing the selected gesture to cause the avatar to enact the selected gesture in conjunction with conveying the verbal communication.

16. The method of claim 15, further comprising:
parsing a text string; and
determining a meaning of the parsed text string using at least one of a plurality of semantic analysis techniques, wherein the plurality of analysis techniques comprise morphological analysis and syntactical analysis.

17. The method of claim 16, further comprising:
comparing the parsed text string to entries in a syntax database, wherein the entries in the syntax database define associations between elements of common text strings and a semantic meaning of the elements of the common text strings; and
determining whether a match exists between the parsed text string and the entries in the syntax database.

18. The method of claim 17, further comprising:
comparing a derived meaning of the text string to entries in a gesture database, wherein the derived meaning of the text string is based on the match between the parsed text string and the entries in the syntax database, wherein the entries in the gesture database define associations between the semantic meanings of the elements of the common text strings and a plurality of gestures; and
determining whether a match exists between the derived meaning of the text string and the entries in the gesture database.

19. The method of claim 15, further comprising:
defining the association between the verbal communication and the gesture in the metaverse application; and
allowing a user to modify existing associations between user generated text and at least one of a plurality of gestures in the metaverse application.

20. The method of claim 15, further comprising:
storing associations between common text strings and semantic meanings of the common text strings, wherein the common text strings and the semantic meanings are stored in an arrangement to define associations between the common text strings and semantic meanings of the common text strings; and
storing associations between the semantic meanings of common text strings and a plurality of gestures, wherein the common text strings and the semantic meanings are stored in an arrangement to define associations between the semantic meanings of common text strings and the plurality of gestures.
